(19) United States
(12) Patent Application Publication
(10) Pub. No.: US 2011/0285801 A1
(43) Pub. Date: Nov. 24, 2011

(54) INKJET PRINTER

(75) Inventors: Yuma Okura, Nnagano (JP); Tetsuharu Ikeda, Nagano (JP); Takahiro Hasegawa, Nagano (JP); Masakazu Nakazawa, Nagano (JP)

(73) Assignee: MIMAKI ENGINEERING CO., LTD., NAGANO (JP)

(21) Appl. No.: 13/146,919

(22) PCT Filed: Jan. 30, 2009
(86) PCT No.: PCT/JP2009/051659

§ 371 Date: Jul. 29, 2011

(51) Int. Cl. B41J 2/01

(52) U.S. Cl. 347/104

(57) ABSTRACT

An inkjet printer (P) is provided with a platen (20) which supports a printing medium, a printing means comprised of a carriage (40), an inkjet head (60) and the like for performing printing on the printing medium (M) that is supported by the platen (20), a medium feeding device (3) which supports a feeding shaft around which the printing medium (M) in an elongated sheet shape is wound and in which the feeding shaft is rotated to feed out the printing medium (M) toward the platen (20), and a medium winding device (4) which has the same shape as the medium feeding device (3) and supports a winding shaft for winding the printing medium (M) and in which the winding shaft is rotated for winding the printing medium (M) that has been fed out by the medium feeding device (3) and has been printed by the printing means.

### BACKGROUND OF THE INVENTION

1. Technical Field

The present invention relates to an inkjet printer which performs printing on a printing medium in an elongated sheet shape.

2. Background Art

Conventionally, as an inkjet printer performing printing on a printing medium in an elongated sheet shape, an inkjet printer has been known which is structured so that a printing medium before printing is fed out by a feeding mechanism that is disposed on a rear side of a printer main body, ink is ejected while an inkjet head is relatively moved with respect to the printing medium to perform printing in the printer main body, and the printing medium after printing is wound up by a winding mechanism that is disposed on a front side of the printer main body (see, for example, Patent Literature 1). In the inkjet printer described above, in order to appropriately feed out or wind up a printing medium without cockles and slackness, a tension applying mechanism which applies a predetermined tension to the printing medium may be provided on a feeding mechanism side or a winding mechanism side (see, for example, Patent Literature 2 and Patent Literature 3).

[Patent Literature 1] Japanese Patent Laid-Open No. 2007-302468

[Patent Literature 2] Japanese Patent Laid-Open No. 2008-279621

[Patent Literature 3] Japanese Patent Laid-Open No. 2003-252501

### SUMMARY OF THE INVENTION

### Technical Problem

The feeding mechanism and the winding mechanism are generally provided with a basically similar structure because a feeding shaft is rotated to feed out a printing medium or a winding shaft is rotated to wind up the printing medium. On the other hand, for example, in the winding mechanism, since a feeding path is required to set longer for drying of ink or the like, the feeding mechanism and the winding mechanism are often structured by using different structural members from each other. In this case, the number of part items structuring the feeding mechanism and the winding mechanism is increased and the structure is complicated and thus component management is complicated and its manufacturing cost is increased.

In view of the problems described above, an objective of the present invention is to provide an inkjet printer in which structural members of the medium feeding device and the medium winding device are commonly used to attain that component management is easy and its manufacturing cost is reduced.

### Solution to Problem

In order to attain the above-mentioned objective, the present invention provides an inkjet printer including a platen which supports a printing medium, a printing means (for example, the carriage 40, the inkjet head 60 and the like in the embodiment) which is oppositely disposed to the platen for performing printing on the printing medium that is supported by the platen, a medium feeding means (for example, the first medium support mechanism 80 in the embodiment) which supports a feeding shaft around which the printing medium in an elongated sheet shape is wound and in which the feeding shaft is rotated to feed out the printing medium toward the platen, and a medium winding means (for example, the second medium support mechanism 110 in the embodiment) which has the same shape as the medium feeding means and supports a winding shaft for winding the printing medium and in which the winding shaft is rotated for winding the printing medium that has been fed out by the medium feeding means and has been printed by the printing means around the winding shaft. The medium feeding means and the medium winding means are disposed on both sides in a feeding direction of the printing medium with respect to the platen so as to be symmetrical in a side view.

In the inkjet printer which is structured as described above, it is preferable that the inkjet printer further includes a first tension applying means (for example, the first tension applying mechanism 90 in the embodiment) in which a first tension bar that is extended in a perpendicular direction perpendicular to the feeding direction of the printing medium is abutted by own weight of the first tension bar with the printing medium which is fed out by the medium feeding means and before reaching to the platen so that the printing medium is bent, and a second tension applying means (for example, the second tension applying mechanism 120 in the embodiment) which has the same shape as the first tension applying means and in which a second tension bar that is extended in the perpendicular direction is abutted by own weight of the second tension bar with the printing medium which is fed out from the platen and before being wound by the medium winding means so that the printing medium is bent. The first tension applying means and the second tension applying means are disposed on both sides in the feeding direction of the printing medium with respect to the platen so as to be symmetrical in a side view.

Further, in the inkjet printer which is structured as described above, it is preferable that the inkjet printer further includes a first tension bar position detecting means (for example, the first swing angle detecting part 95 in the embodiment) for detecting a height position of the first tension bar, a feeding controller which controls an operation of the medium feeding means depending on the height position of the first tension bar that is detected by the first tension bar position detecting means, a second tension bar position detecting means (for example, the second swing angle detecting part 125 in the embodiment) for detecting a height position of the second tension bar, and a winding controller which controls an operation of the medium winding means depending on the height position of the second tension bar that is detected by the second tension bar position detecting means. The first tension bar position detecting means and the feeding controller, and the second tension bar position detecting means and the winding controller are disposed on both sides in the feeding direction of the printing medium with respect to the platen and disposed on the same side of the perpendicular direction.

### ADVANTAGEOUS EFFECTS OF INVENTION

According to the inkjet printer in accordance with the present invention, the medium feeding means and the medium winding means have the same shape as each other and are disposed on both sides with respect to the platen in a feeding direction of the printing medium so as to be symmetrical in a side view. In other words, the number of part items is reduced by commonly using the structural members of the medium feeding device and the medium winding device and thus management of the part items is easy and the manufacturing cost can be reduced. Further, the medium feeding device and the medium winding device can be assembled or disassembled in the same order of steps and thus workability in the manufacturing step or the maintenance step is improved.

In the above-mentioned inkjet printer, it is preferable that the inkjet printer is provided with a first tension applying means for applying a tension to the printing medium which is fed out by the medium feeding means and before reaching to the platen, and a second tension applying means for applying a tension to the printing medium which is fed out from the platen and before being wound by the medium winding device, and the inkjet printer is structured so that the first tension applying means and the second tension applying means have the same shape as each other and are disposed on both sides with respect to the platen in the feeding direction of the printing medium so as to be symmetrical in a side view. According to this structure, the number of part items of the first tension applying means and the second tension applying means is also reduced and thus management of the part items is easy and the manufacturing cost can be reduced.

Further, in the above-mentioned inkjet printer, it is preferable that the inkjet printer is provided with a first tension bar position detecting means for detecting a height position of the first tension bar, a feeding controller which controls an operation of the medium feeding means depending on the height position of the first tension bar that is detected by the first tension bar position detecting means, a second tension bar position detecting means for detecting a height position of the second tension bar, and a winding controller which controls an operation of the medium winding means depending on the height position of the second tension bar that is detected by the second tension bar position detecting means. In addition, it is preferable that the inkjet printer is structured so that the first tension bar position detecting means and the feeding controller and the second tension bar position detecting means and the winding controller are disposed on both sides with respect to the platen in the feeding direction of the printing medium and disposed on the same side of the perpendicular direction. According to this structure, workability for the maintenance or the like is improved.

### BRIEF DESCRIPTION OF THE DRAWINGS

FIG. 1 is a side view showing an inkjet printer in accordance with the present invention.

FIG. 2 is a perspective view showing the inkjet printer which is viewed from a front side.

FIG. 3 is a front view showing a main structure of a printer main body which structures the inkjet printer.

FIG. 4 is a side view showing a structure of a medium feeding device and a medium winding device which structure the inkjet printer.

FIG. 5 is a plan view (partly cross section) showing the structure of the medium feeding device and the medium winding device.

### REFERENCE SIGNS LIST

“M” printing medium

1 printer main body

3 medium feeding device

4 medium winding device

6 feeding shaft

8 winding shaft

20 platen

40 carriage (printing means)

60 inkjet head (printing means)

80 first medium support mechanism (medium feeding means)

90 first tension applying mechanism (first tension applying means)

91 first tension bar

95 first swing angle detecting part (first tension bar position detecting means)

100 feeding controller

110 second medium support mechanism (medium winding means)

120 second tension applying mechanism (second tension applying means)

121 second tension bar

125 second swing angle detecting part (second tension bar position detecting means)

130 winding controller

### DESCRIPTION OF THE EMBODIMENTS

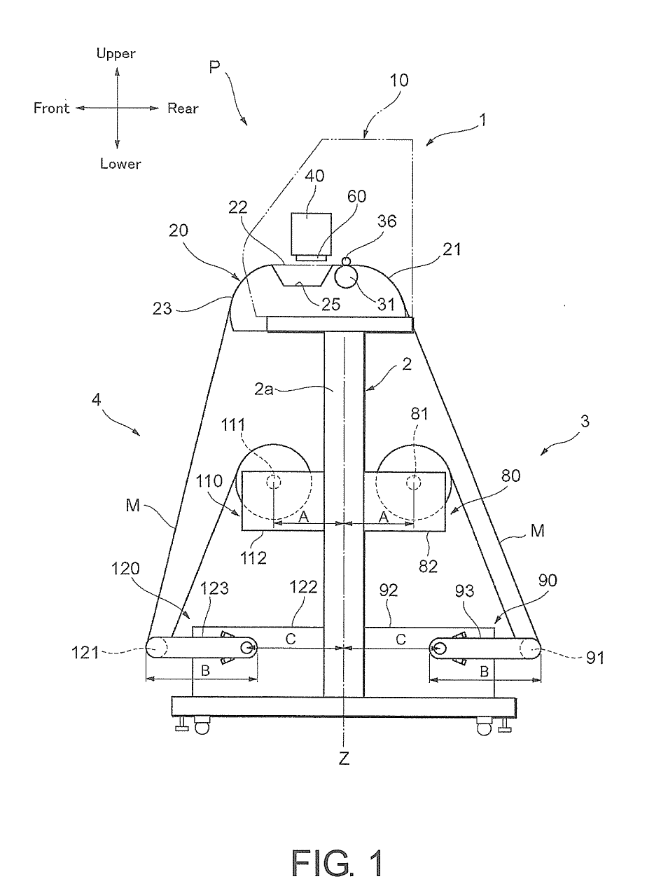

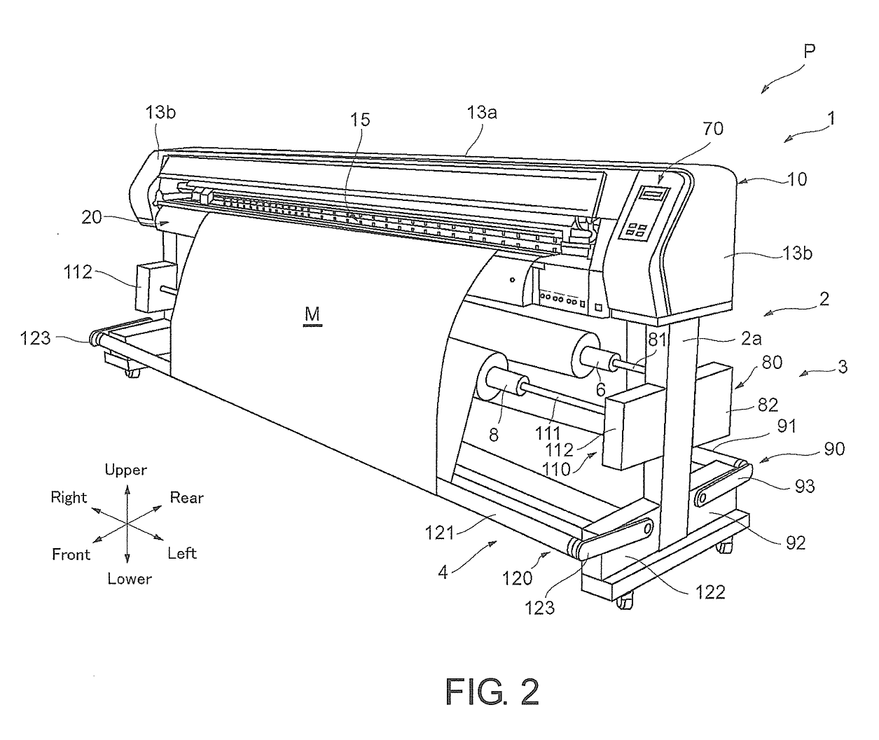

A preferred embodiment of the present invention will be described below with reference to the accompanying drawings. As shown in FIGS. 1 and 2, an inkjet printer “P” in accordance with the present invention is structured of a printer main body 1 which performs printing on a sheet-shaped printing medium “M”, a support part 2 which supports the printer main body 1 at a height position where working is easily performed, a medium feeding device 3 for feeding out the printing medium “M” in an unprinted state to the printer main body 1, and a medium winding device 4 for winding the printing medium “M” after printing has been finished. In the following description, directions in the drawings indicated by the arrows of front and rear, right and left, upper and lower are respectively referred to as a front and rear direction, a right and left direction and an upper and lower direction for convenience of description.

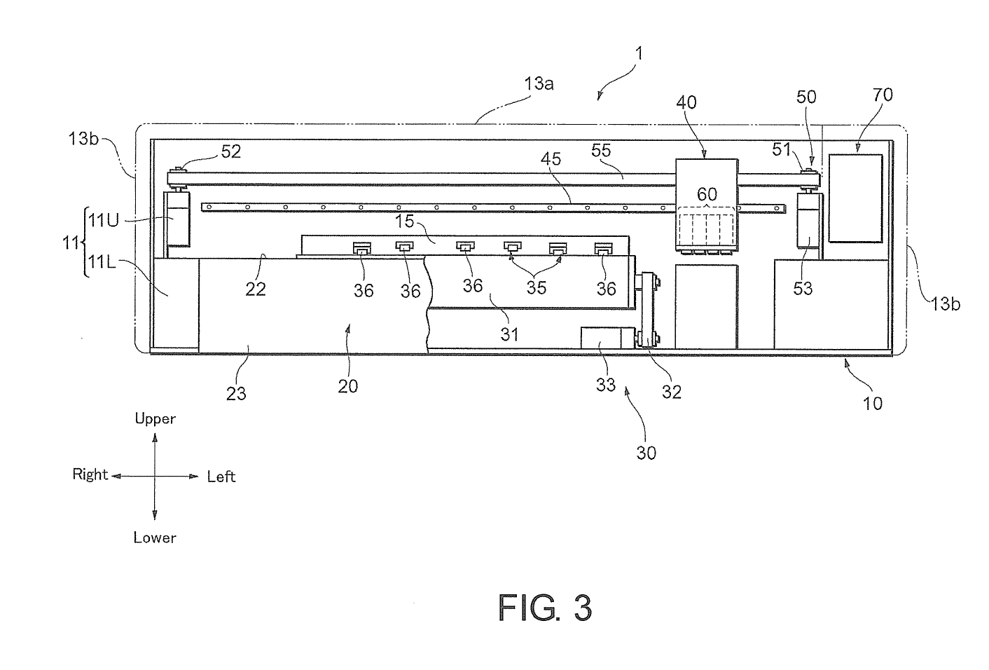

First, the printer main body 1 will be briefly described below with reference to FIG. 3 which shows a main structure of the printer main body 1. The printer main body 1 is mainly structured of a body 10 which is a mounting base for respective units, a platen 20 which supports a printing medium “M”, a medium moving mechanism 30 which moves the printing medium “M” that is supported on the platen 20 in a front and rear direction, a carriage 40 which is located on an upper side of the platen 20 and is supported in a movable state in a right and left direction, a carriage moving mechanism 50 which relatively moves the carriage 40 in the right and left direction with respect to the printing medium “M” that is placed on the platen 20, a plurality of inkjet heads 60 which are fixed and supported by the carriage 40, and a printing controller 70 which controls the drives of the respective moving mechanisms 30 and 50, ink ejection from the inkjet heads 60 and the like.

The body 10 is provided with a main body frame 11 comprised of a lower frame 11L, which is supported by right and left supporting legs 2a structuring the support part 2 and to which the platen 20 is attached, and an upper frame 11 U to which a support structure of the carriage 40 is attached. A medium passing part 15 formed in a laterally long window shape is formed between the upper frame 11U and the lower frame 11L so that a printing medium “M” is capable of passing through in the front and rear direction. The body 10 is surrounded by a front cover 13a which covers a center part of the main body frame 11 and side covers 13b which cover the right and left sides and structured in a laterally long rectangular boxlike shape as a whole.

The platen 20 is located at a center part in the right and left direction of the body 10 and provided in the front and rear direction with respect to the medium passing part 15. The platen 20 is structured of a main platen 22, which is formed with a support face for supporting a printing medium “M” horizontally at a printing part (printing region) where the inkjet heads 60 are moved in the right and left direction to perform printing, a rear platen 21 which is extended backward from the main platen 22 and provided on a rear face side of the body 10, and a front platen 23 which is extended forward from the main platen 22 and provided on a front face side of the body 10. A rear end side of the rear platen 21 and a front end side of the front platen 23 are respectively extended downward in a smooth curved shape. A printing medium “M” which is fed out from the medium feeding device 3 into the platen 20 is smoothly moved through respective upper faces of the rear platen 21, the main platen 22 and the front platen 23 in this order and then, the printing medium “M” is fed out from the front platen 23 and wound by the medium winding device 4.

The support face of the main platen 22 is formed with a large number of suction holes whose diameter is around several millimeters and a decompression chamber 25 which is capable of setting in a negative pressure is provided on a lower side of the support face. The printing medium “M” is sucked and held at the printing part by setting the decompression chamber 25 in a negative pressure and the position of the printing medium “M” is not displaced during printing.

The medium moving mechanism 30 is structured of a feed roller 31 formed in a cylindrical tube shape, which is turnably provided around a rotation shaft extended in the right and left direction and disposed so that its upper peripheral face is exposed from the support face of the main platen 22, a roller drive motor 33 for rotatably driving the feed roller 31, a timing belt 32 which is stretched over a driven pulley coupled to a shaft end of the feed roller 31 and a drive pulley coupled to a shaft end of the roller drive motor 33, and a plurality of roller assemblies 35 which are provided with a pinch roller 36 that is rotatable in the front and rear direction and are disposed on an upper side of the feed roller 31 with a predetermined interval in the right and left direction.

The roller assembly 35 is structured so that the pinch roller 36 is capable of being displaced between a clamp position where the pinch roller 36 is elastically engaged with the feed roller 31 and an unclamp position where the pinch roller 36 is separated to an upper side of the feed roller 31. When the feed roller 31 is turned in a state that the roller assemblies 35 are set in the clamp position and a printing medium “M” is sandwiched between the upper and lower rollers 36 and 31, the printing medium “M” is carried in the front and rear direction by a feeding amount corresponding to a turning angle of the feed roller 31, in other words, by a feeding amount corresponding to a drive control signal which is outputted from the printing controller 70 to the roller drive motor 33.

The carriage 40 is supported to be movable in the right and left direction by the guide rail 45, which is attached to the upper frame 11U and extended in the right and left direction in parallel to the feed roller 31. The guide rail 45 is a support rail of a linear bearing. The carriage 40 is fixed to a slide block which is fitted to the guide rail 45 so as to be slidably supported in the right and left direction and the carriage 40 is moved in the right and left direction by the carriage moving mechanism 50.

The carriage moving mechanism 50 is comprised of a drive pulley 51 and a driven pulley 52 which are provided in the vicinities of right and left side ends of the guide rail 45, a carriage drive motor 53 for rotationally driving the drive pulley 51, and a timing belt 55 which is stretched over the drive pulley 51 and the driven pulley 52. The carriage 40 is connected and fixed to the timing belt 55. Rotation of the carriage drive motor 53 is controlled by the printing controller 70 and the carriage 40 is slidably moved (moved in a reciprocated manner) in the right and left direction by a feeding amount corresponding to a drive control signal which is outputted from the printing controller 70 to the carriage drive motor 53.

The inkjet head 60 is formed on its under face with a large number of nozzles for ejecting ink droplets and the inkjet head 60 is fixed and supported by the carriage 40 so that its under face (nozzle face) is separated from a printing medium “M” with a predetermined gap space (distance). Various types of arrangement structure of the inkjet head 60 have been proposed and an appropriate structure may be utilized. In this embodiment, a head structure is adopted in which inkjet heads 60 for four colors (for example, black, cyan, magenta and yellow) are disposed in the right and left direction in a juxtaposed manner. Further, the carriage 40 is capable of moving upward and downward by a carriage up-and-down mechanism not shown and a gap between the nozzle face of the inkjet heads 60 and a printing medium “M” can be adjusted depending on a surface condition of the printing medium “M” or the like by utilizing the carriage up-and-down mechanism.

The printing controller 70 controls drive of the roller drive motor 33 in the medium moving mechanism 30 to intermittently feed forward and position a printing medium “M” that is supported on the platen 20 and, in addition, synchronously controls drive of the carriage drive motor 53 in the carriage moving mechanism 50 and ink ejection from the nozzles of the respective inkjet heads 60 to form image such as a character or a pattern corresponding to a printing program on the printing medium “M”. In this case, a printing medium “M” in an unprinted state is fed out by the medium feeding device 3 to feed into the platen 20 depending on a feeding amount of the printing medium “M” on the platen 20 by the medium moving mechanism 30, and the printing medium “M” after printing has finished and fed out from the platen 20 is wound by the medium winding device 4.

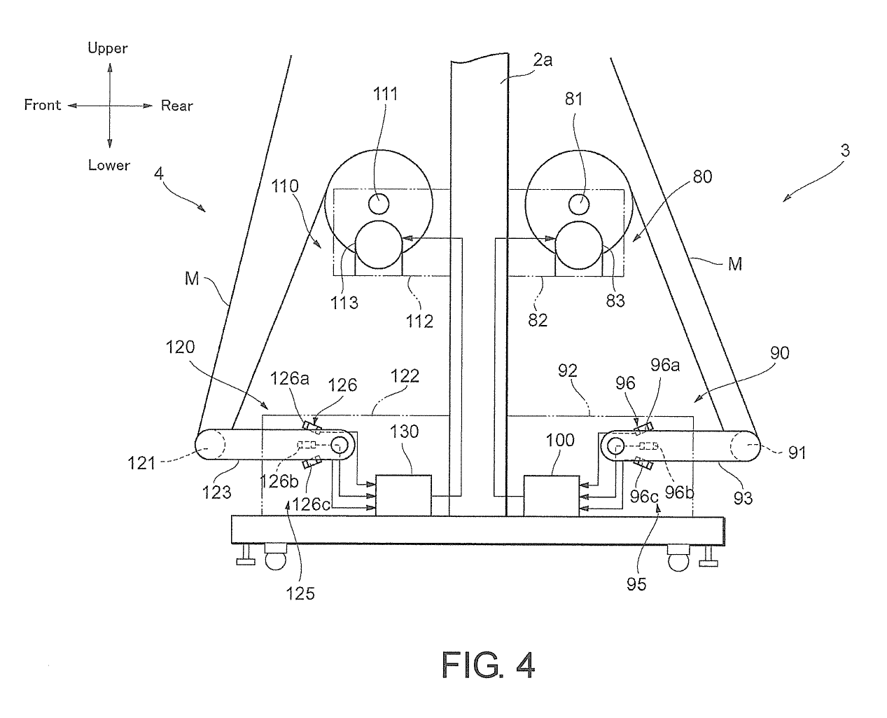

Next, the medium feeding device 3 and the medium winding device 4 will be described below. The medium feeding device 3 is, as shown in FIGS. 1 and 4, provided on the rear side of the supporting leg 2a. The medium feeding device 3 is structured of a first medium support mechanism 80, which supports a feeding shaft 6 in a tube-like shape (see FIG. 2) around which a printing medium “M” in an unprinted state is wound and rotates the feeding shaft 6 for feeding out the printing medium “M”, a first tension applying mechanism 90 which applies a tension to the printing medium “M” in an opposite direction to the feeding direction, and a feeding controller 100 which controls a feeding amount of the printing medium “M” by the first medium support mechanism 80.

The first medium support mechanism 80 is structured of a bar-like support shaft 81 which is inserted into the feeding shaft 6 and integrally rotatable with the feeding shaft 6, right and left shaft support parts 82 which are disposed at intermediate portions on the rear sides of the right and left supporting legs 2a and rotatably and detachably support the support shaft 81, and a shaft drive motor 83 which is provided within the left side shaft support part 82 for rotationally driving the support shaft 81.

The shaft drive motor 83 is driven and controlled by the feeding controller 100 and the support shaft 81 is rotationally driven through gears not shown depending on a drive control signal inputted from the feeding controller 100. A printing medium “M” in an unprinted state which is supported so as to be extended in a substantially horizontal direction between the right and left shaft support parts 82 by the support shaft 81 is fed out toward the platen 20 (rear platen 21) with a feeding amount (at a feeding speed) corresponding to a rotation amount (rotation speed) of the support shaft 81.

The first tension applying mechanism 90 is comprised of a first tension bar 91 which is formed in a cylindrical bar shape and transversely abutted in the right and left direction with an inner side of a midway part of the printing medium “M” which is fed out from the feeding shaft 6 and fed into the platen 20, a pair of right and left arm support parts 92 which are disposed at lower end parts on the rear side of the right and left supporting legs 2a, a pair of right and left support arms 93 whose base end parts are turnably supported by side faces of the right and left arm support parts 92 so that the support arms 93 are swingable in the upper and lower direction, and a first swing angle detecting part 95 which detects a swing angle of the support arms 93. The first tension applying mechanism 90 is structured so that both ends of the first tension bar 91 are rotationally supported at tip end parts of the right and left support arms 93. In this embodiment, the first swing angle detecting part 95 is a detecting part which is capable of detecting a height position of the first tension bar 91 by detecting a swing angle of the support arm 93.

In the first tension applying mechanism 90, the support arms 93 are swung downward by the own weights of the first tension bar 91 and the right and left support arms 93, and the first tension bar 91 is abutted with the inner side of the printing medium “M” so that the printing medium “M” is bent at a position after the printing medium “M” is fed out from the feeding shaft 6 and before fed into the platen 20. In this manner, a tension corresponding to a height position of the first tension bar 91, in other words, a tension corresponding to a swing angle of the support arm 93 is applied to the printing medium “M”.

The first swing angle detecting part 95 is structured of an encoder sensor (not shown) which is attached in the vicinity of a rotation shaft of the left side support arm 93, an encoder scale (not shown) which is fixed to the rotation shaft of the support arm 93, three transmission type photo sensors 96 (upper photo sensor 96a, intermediate photo sensor 96b, lower photo sensor 96c) which are attached to a side face of the left side arm support part 92 (a face oppositely disposed to the support arm 93) so as to be vertically arranged side by side, and an intercepting plate (not shown) which is formed on the side face of the support arm 93 so as to extend toward the arm support part 92. A swing angle of the support arm 93 detected by the encoder sensor and a detection signal by the photo sensor 96 are outputted to the feeding controller 100.

The feeding controller 100 is disposed in the inside of the left side arm support part 92. When printing is to be performed, drive of the shaft drive motor 83 of the first medium support mechanism 80 is controlled so that a printing medium “M” supported by the support shaft 81 is fed out with a predetermined feeding amount on the basis of a feeding amount of the printing medium “M” on the platen 20 by the medium moving mechanism 30 (see FIG. 3) and the feeding amount is adjusted depending on a swing angle of the support arm 93 which is detected by the encoder sensor and the encoder scale. Further, at the time of non-printing such as fast forwarding of the printing medium “M”, drive of the shaft drive motor 83 is controlled depending on a swing angle of the support arm 93 detected by the photo sensor 96 to control a feeding amount of the printing medium “M”. Specifically, when the intermediate and the lower photo sensors 96b and 96c do not detect the intercepting plate of the support arm 93 (when the intercepting plate is located between the intermediate photo sensor 96b and the lower photo sensor 96c), the printing medium “M” is controlled to be fed out and, when the intermediate photo sensor 96b or the lower photo sensor 96c detects the intercepting plate, the feeding of the printing medium “M” is controlled to be stopped. In this embodiment, the upper photo sensor 96a is a limit sensor and, when the upper photo sensor 96a detects the intercepting plate due to any fault or the like, the apparatus is forcibly stopped.

As described above, a feeding amount of the printing medium “M” is adjusted depending on a swing angle of the support arm 93 that is detected by the first swing angle detecting part 95. Therefore, a height position of the first tension bar 91 is capable of maintaining at a substantially constant position and thus a substantially constant tension can be applied to the printing medium “M”. For example, when the support arm 93 is maintained substantially horizontal, a tension is efficiently applied to the printing medium “M” by the own weights of the first tension bar 91 and the support arm 93.

The medium winding device 4 is, as shown in FIGS. 1 and 4, provided on the front side of the supporting leg 2a. The medium winding device 4 is structured of a second medium support mechanism 110, which supports a winding shaft 8 in a tube-like shape (see FIG. 2) around which the printing medium “M” after having been printed is wound, and rotates the winding shaft 8 for winding the printing medium “M”, a second tension applying mechanism 120 which applies a tension to the printing medium “M” in a feeding direction, and a winding controller 130 which controls a winding amount of the printing medium “M” by the second medium support mechanism 110. In this embodiment, the medium winding device 4 is basically structured to be similar to the medium feeding device 3.

The second medium support mechanism 110 is structured of a bar-like support shaft 111 which is inserted into the winding shaft 8 and integrally rotatable with the winding shaft 8, right and left shaft support parts 112 which are disposed at intermediate portions on the front sides of the right and left supporting legs 2a and rotatably and detachably support the support shaft 111, and a shaft drive motor 113 which is provided within the left side shaft support part 112 for rotationally driving the support shaft 111.

The shaft drive motor 113 is driven and controlled by the winding controller 130 and rotationally drives the support shaft 111 through gears not shown depending on a drive control signal inputted from the winding controller 130. The printing medium “M” having been printed which is fed out from the platen 20 (front platen 23) is wound around the winding shaft 8 which is extended substantially horizontal and supported between the right and left shaft support parts 112 through the support shaft 111 with a winding amount (at a winding speed) corresponding to a rotation amount (rotation speed) of the support shaft 111.

The second tension applying mechanism 120 is comprised of a second tension bar 121 which is formed in a cylindrical bar shape and transversely abutted in the right and left direction with an inner side of a midway part of the printing medium “M” which is fed out from the platen 20 and wound around the winding shaft 8, right and left arm support parts 122 which are disposed at lower end parts on the front side of the right and left supporting legs 2a, a pair of right and left support arms 123 whose base end parts are turnably supported by side faces of the right and left arm support parts 122 so that the support arms 123 are swingable in the upper and lower direction, and a second swing angle detecting part 125 which detects a swing angle of the support arms 123. The second tension applying mechanism 120 is structured so that both ends of the second tension bar 121 are rotationally supported at tip end parts of the right and left support arms 123. In this embodiment, the second swing angle detecting part 125 is a detecting part which is capable of detecting a height position of the second tension bar 121 by detecting a swing angle of the support arm 123.

In the second tension applying mechanism 120, the support arms 123 are swung downward by the own weights of the second tension bar 121 and the right and left support arms 123, and the second tension bar 121 is abutted with the inner side of the printing medium “M” so that the printing medium “M” is bent at a position after the printing medium “M” is fed out from the platen 20 and before wound around the winding shaft 8. In this manner, a tension corresponding to a height position of the second tension bar 121, in other words, a tension corresponding to a swing angle of the support arm 123 is applied to the printing medium “M”.

The second swing angle detecting part 125 is structured of an encoder sensor (not shown) which is attached in the vicinity of a rotation shaft of the left side support arm 123, an encoder scale (not shown) which is fixed to the rotation shaft of the support arm 123, three transmission type photo sensors 126 (upper photo sensor 126a, intermediate photo sensor 126b, lower photo sensor 126c) which are attached to a side face of the left side arm support part 122 (a face oppositely disposed to the support arm 123) so as to be vertically arranged side by side, and an intercepting plate (not shown) which is formed on the side face of the support arm 123 so as to extend toward the arm support part 122. A swing angle of the support arm 123 detected by the encoder sensor and a detection signal by the photo sensor 126 are outputted to the winding controller 130.

The winding controller 130 is disposed in the inside of the left side arm support part 122. At the time of printing, a drive of the shaft drive motor 113 of the second medium support mechanism 110 is controlled so that the printing medium “M” supported by the support shaft 111 is wound with a predetermined winding amount on the basis of the feeding amount of the printing medium “M” on the platen 20 by the medium moving mechanism 30 (see FIG. 3) and the winding amount is adjusted depending on a swing angle of the support arm 123 which is detected by the encoder sensor and the encoder scale. Further, at the time of non-printing such as fast forwarding of the printing medium “M”, drive of the shaft drive motor 113 is controlled depending on a swing angle of the support arm 123 detected by the photo sensor 126 to control a winding amount of the printing medium “M”. Specifically, when the intermediate and the lower photo sensors 126b and 126c do not detect the intercepting plate of the support arm 123 (when the intercepting plate is located between the intermediate photo sensor 126b and the lower photo sensor 126c), the printing medium “M” is controlled to be wound and, when the intermediate photo sensor 126b or the lower photo sensor 126c detects the intercepting plate, the winding of the printing medium “M” is controlled to be stopped. In this embodiment, the upper photo sensor 126a is a limit sensor and, when the upper photo sensor 126a detects the intercepting plate due to any fault or the like, the apparatus is forcibly stopped.

As described above, a winding amount of the printing medium “M” is adjusted depending on a swing angle of the support arm 123 which is detected by the first swing angle detecting part 125. Therefore, a height position of the second tension bar 121 is capable of maintaining at a substantially constant position and thus a substantially constant tension can be applied to the printing medium “M”. For example, when the support arm 123 is maintained to be substantially horizontal, a tension is efficiently applied to the printing medium “M” by the own weights of the second tension bar 121 and the support arm 123.

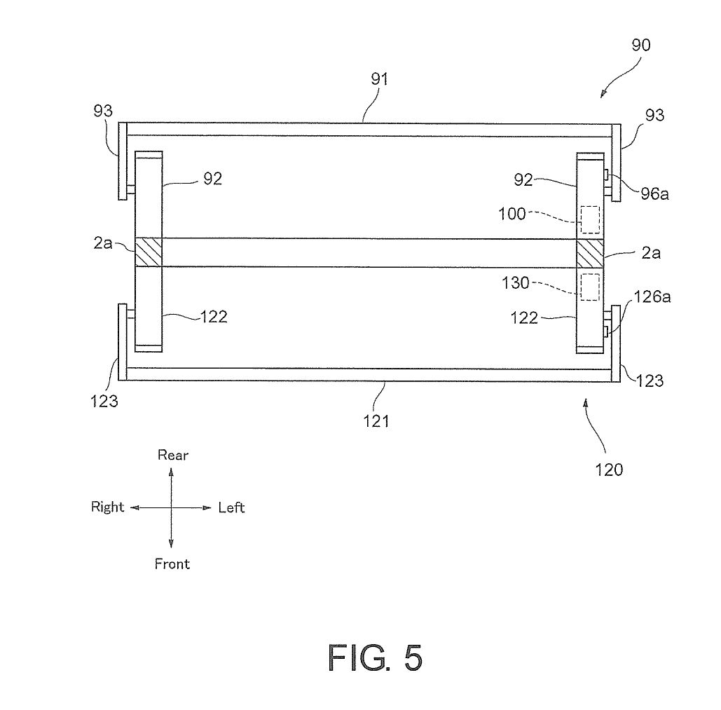

In the medium feeding device 3 and the medium winding device 4 which are structured as described above, as shown in FIGS. 1 and 5, the shaft support parts 82 and 112 of the medium support mechanisms 80 and 110 and the arm support parts 92 and 122 and the support arms 93 and 123 of the tension applying mechanisms 90 and 120 respectively have the same shape as each other (respectively structured to be symmetrical in the right and left direction), and the medium feeding device 3 and the medium winding device 4 are disposed to be symmetrical in the front and rear direction interposing the platen 20 (right and left supporting legs 2a) in the side view.

Specifically, the first medium support mechanism 80 (shaft support part 82) and the second medium support mechanism 110 (shaft support part 112) are disposed at the same height as each other in the front and rear direction of the supporting leg 2a, and the respective support shafts 81 and 111 are supported at the same height as each other and at positions of the same distance “A” in the front and rear direction from a symmetrical axis “Z” which is vertically extended through the center in the front and rear direction of the supporting leg 2a. Further, the first tension applying mechanism 90 and the second tension applying mechanism 120 are structured so that the respective arm support parts 92 and 122 are disposed at the same height as each other in the front and rear direction of the supporting leg 2a and, so that the base end parts of the respective support arms 93 and 123 having the same length “B” are turnably supported by the respective arm support parts 92 and 122 at the same height as each other and at positions having the same distance “C” in the front and rear direction from the symmetrical axis “Z”. Further, the respective shaft drive motors 83 and 113 are provided in the insides of the respective left side shaft support parts 82 and 112, and the respective swing angle detecting parts 95 and 125, the feeding controller 100 and the winding controller 130 are disposed in the respective left side arm support parts 92 and 122. In this embodiment, the distance “A”, the length “B”, the distance “C” and the like may be appropriately modified.

As described above, the medium feeding device 3 and the medium winding device 4 are provided with the same shape as each other and symmetrically disposed and structured in the front and rear direction so as to interpose the platen 20 (right and left supporting legs 2a) between them. In other words, most of the structural members of the medium feeding device 3 and the medium winding device 4 are commonly used and thus the number of part items for the structural members is reduced. Therefore, management of part items is easy and the manufacturing cost can be reduced. Further, the medium feeding device 3 and the medium winding device 4 can be assembled or disassembled in the same order of steps and thus workability in the manufacturing step or the maintenance step is improved. Further, since the respective shaft drive motors 83 and 113, the respective swing angle detecting parts 95 and 125, the feeding controller 100 and the winding controller 130 are disposed on the same side (left side) of the respective devices 3 and 4, workability of the maintenance or the like is improved.

What is claimed is:

1. An inkjet printer comprising:
a platen which supports a printing medium;
a printing means which is oppositely disposed to the platen for performing printing on the printing medium that is supported by the platen;
a medium feeding means which supports a feeding shaft around which the printing medium in an elongated sheet shape is wound and in which the feeding shaft is rotated to feed out the printing medium toward the platen; and
a medium winding means which has same shape as the medium feeding means and supports a winding shaft for winding the printing medium and in which the winding shaft is rotated for winding the printing medium that has been fed out by the medium feeding means and has been printed by the printing means around the winding shaft;
wherein the medium feeding means and the medium winding means are disposed on both sides in a feeding direction of the printing medium with respect to the platen so as to be symmetrical in a side view.

2. The inkjet printer according to claim 1, further comprising:
a first tension applying means in which a first tension bar that is extended in a perpendicular direction perpendicular to the feeding direction of the printing medium is abutted by own weight of the first tension bar with the printing medium which is fed out by the medium feeding means and before reaching to the platen so that the printing medium is bent; and
a second tension applying means which has same shape as the first tension applying means and in which a second tension bar that is extended in the perpendicular direction is abutted by own weight of the second tension bar with the printing medium which is fed out from the platen and before being wound by the medium winding means so that the printing medium is bent;
wherein the first tension applying means and the second tension applying means are disposed on both sides in the feeding direction of the printing medium with respect to the platen so as to be symmetrical in a side view.

3. The inkjet printer according to claim 2, further comprising:
a first tension bar position detecting means for detecting a height position of the first tension bar;
a feeding controller which controls an operation of the medium feeding means depending on the height position of the first tension bar that is detected by the first tension bar position detecting means;
a second tension bar position detecting means for detecting a height position of the second tension bar; and
a winding controller which controls an operation of the medium winding means depending on the height position of the second tension bar that is detected by the second tension bar position detecting means;
wherein the first tension bar position detecting means and the feeding controller and the second tension bar position detecting means and the winding controller are disposed on both sides in the feeding direction of the printing medium with respect to the platen and disposed on same side of the perpendicular direction.
